(19) United States
(12) Patent Application Publication
(10) Pub. No.: US 2006/0009967 A1
(43) Pub. Date: Jan. 12, 2006

(54) Sinusoidal audio coding with phase updates

(76) Inventors: Andreas Johannes Gerrits, Eindhoven (NL); Albertus Cornelis Den Brinker, Eindhoven (NL); Gerard Herman Hotho, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,015

(22) PCT Filed: Sep. 19, 2003
(86) PCT No.: PCT/IB03/04232

§ 371 Date: Apr. 12, 2005

(30) Foreign Application Priority Data
Oct. 17, 2002 (EP) 02079353.5

(51) Int. Cl. G10L 11/00

(52) U.S. Cl. 704/200

(57) ABSTRACT

Coding of an audio signal (x) represented by a respective set of sampled signal values for each of a plurality of sequential segments is disclosed. The sampled signal values are analyzed (130) to generate one or more sinusoidal components (fₖ,fₖ₋₁) for each of the plurality of sequential segments. Sinusoidal codes (CS) comprising tracks of linked sinusoidal components (fₖ,fₖ₋₁) are generated (13) and phase update information (Φₖ, Δₖ) indicative of the phase value of selected sinusoidal components in a track is determined. An encoded audio stream (AS) including said sinusoidal codes (CS) and said phase update information (Φₖ, Δₖ) is then generated (15).

### FIELD OF THE INVENTION

The present invention relates to coding and decoding audio signals.

### BACKGROUND OF THE INVENTION

A parametric coding scheme in particular a sinusoidal coder is described in PCT patent application No. WO 00/79519-A1 (Attorney Ref. PHN 017502) and PCT Patent Application No. IB/02/01297, filed 18.04.2001 (Attorney Ref. PHNL010252). In this coder, an audio segment or frame is modeled by a sinusoidal coder using a number of sinusoids represented by amplitude, frequency and phase parameters. Once the sinusoids for a segment are estimated, a tracking algorithm is initiated. This algorithm tries to link sinusoids with each other on a segment-to-segment basis. Sinusoidal parameters from appropriate sinusoids from consecutive segments are thus linked to obtain so-called tracks. The linking criterion is based on the frequencies of two subsequent segments, but also amplitude and/or phase information can be used. This information is combined in a cost function that determines the sinusoids to be linked. The tracking algorithm thus results in sinusoidal tracks that start at a specific time instance, evolve for a certain amount of time over a plurality of time segments and then stop.

In practical implementations of such prior art coders, for a sinusoidal track, only the initial phase is transmitted by the coder and in the decoder, the continuous phase of a sinusoid in a sinusoidal track is calculated from the phase of the originating sinusoid and the frequencies of the intermediate sinusoids. So, for example, the continuous phase (\tilde{φ}ₖ) of sinusoid k in the track can be calculated as:

$${\tilde{ϕ}}_{k} = {mod}_{2 π} ( {\tilde{ϕ}}_{k - 1} + \frac{L}{2} ( {f}_{k} + {f}_{k - 1} ) ) , \qquad Equation 1$$

where L is the update interval of the frequencies (in sec), typically in the order of 10 ms, and fₖ and fₖ₋₁ are the quantized frequencies (in rad/s) of frame k and k-1, respectively. The function mod represents the modulo operation which maps onto the interval between −π and π. Furthermore, the initial phase k=1) is: \tilde{φ}₁=φ₁ where φ₁ is the measured and quantized phase of the originating sinusoid in a track. Other phase continuation functions are also possible as indicated in European Patent Application No. 01204062.2 filed on 26 Oct. 2001 (Attorney Docket No. PHNL010787) where a warp factor can be determined by the coder and used in linking tracks as well as in the decoder in the calculation of continuous phases.

Nonetheless, especially for long tracks, it is likely that the continuous phase \tilde{φ}ₖ will diverge from the measured phase φₖ to the extent that they do not resemble one another. This divergence can be introduced by inaccuracies in the estimation of the frequencies, the quantization of the frequencies and the initial phase or the linear continuation of the phase. For an individual sinusoidal track, this divergence might not be audible. However, in natural audio, the phase relation between sinusoidal tracks can be important. As such, the loss of phase synchronization between tracks can introduce artefacts like double speaker effect, metallic sound etc.

The loss of phase synchronization between tracks is illustrated quantitatively in FIG. 4. In this figure, the top trace shows a part of a waveform generated by a German male speaker. The middle trace shows the waveform of a corresponding sinusoidal signal generated using a prior art encoder/decoder and the bottom trace shows the difference between the original and the sinusoidal signal. As can be seen from the error signal, the sinusoidal signal does not match the original signal.

The present invention attempts to mitigate this problem.

### DISCLOSURE OF THE INVENTION

According to the present invention there is provided a method according to claim 1.

In the prior art, especially in the case of long tracks decoded with only continuous phase information, the divergence between the continuous and originally measured phase will be large. The phase update method according to the present invention largely removes artefacts introduced by tracks encoded and decoded with a continuous phase.

### BRIEF DESCRIPTION OF THE DRAWINGS

FIG. 1 shows an embodiment of an audio coder according to the invention;

FIG. 2 shows an embodiment of an audio player according to the invention;

FIG. 3 shows a system comprising an audio coder and an audio player according to the invention;

FIG. 4 shows an original waveform (top trace) compared to sinusoidal signal with continuous phase (middle trace) generated with a prior art encoder/decoder and the error signal (bottom trace);

FIG. 5 shows an original waveform (top trace) compared to sinusoidal signal with phase update (middle trace) generated with an encoder/decoder according to a preferred embodiment of the present invention and the error signal (bottom trace); and

FIG. 6 shows the distribution of phase difference (A) for a German male speaker excerpt.

### DESCRIPTION OF THE PREFERRED EMBODIMENT

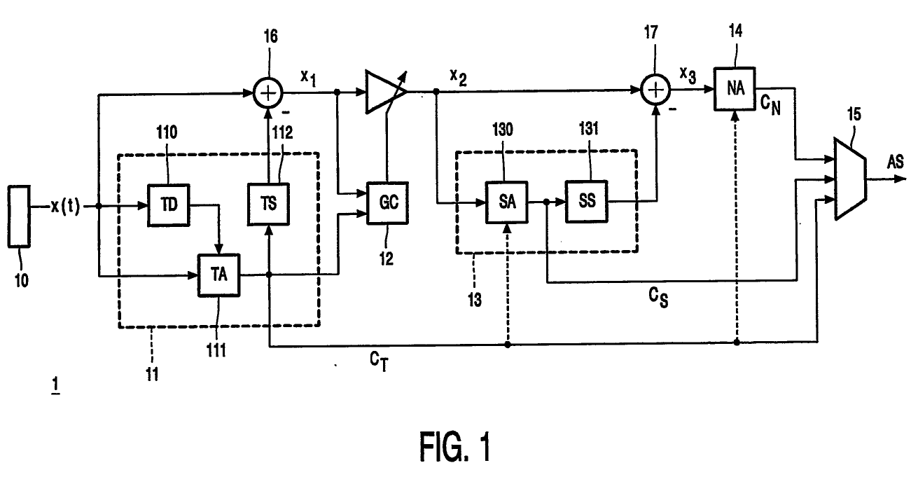

In a preferred embodiment of the present invention, FIG. 1, the encoder is a sinusoidal coder of the type described in WO 01/69593-A1 (Attorney Ref. PH-NL000120). The operation of this coder and its corresponding decoder has been well described and description is only provided here where relevant to the present invention.

In both the earlier case and the preferred embodiment, the audio coder 1 samples an input audio signal at a certain sampling frequency resulting in a digital representation x(t) of the audio signal. The coder 1 then separates the sampled input signal into three components: transient signal components, sustained deterministic components, and sustained stochastic components. The audio coder 1 comprises a transient coder 11, a sinusoidal coder 13 and a noise coder 14. The audio coder optionally comprises a gain compression mechanism (GC) 12.

The transient coder 11 comprises a transient detector (TD) 110, a transient analyzer (TA) 111 and a transient synthesizer (TS) 112. First, the signal x(t) enters the transient detector 110. This detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code CT and more detailed information on generating the transient code CT is provided in WO 01/69593-A1.

The transient code CT is furnished to the transient synthesizer 112. The synthesized transient signal component is subtracted from the input signal x(t) in subtractor 16, resulting in a signal x1. In case the GC 12 is omitted, x1=x2.

The signal x2 is furnished to the sinusoidal coder 13 where it is analyzed in a sinusoidal analyzer (SA) 130, which determines the (deterministic) sinusoidal components. It will therefore be seen that while the presence of the transient analyzer is desirable, it is not necessary and the invention can be implemented without such an analyzer. In any case, the end result of sinusoidal coding is a sinusoidal code CS and a more detailed example illustrating the conventional generation of an exemplary sinusoidal code CS is provided in PCT patent application No. WO 00/79519-A1 (Attorney Ref: PHN 017502).

In brief, however, such a sinusoidal coder encodes the input signal x2 as tracks of sinusoidal components linked from one frame segment to the next. From the sinusoidal code CS generated with the sinusoidal coder, the sinusoidal signal component is reconstructed by a sinusoidal synthesizer (SS) 131. This signal is subtracted in subtractor 17 from the input x2 to the sinusoidal coder 13, resulting in a remaining signal x3 devoid of (large) transient signal components and (main) deterministic sinusoidal components.

Tracks are initially represented by a start frequency, a start amplitude and a start phase for a sinusoid beginning in a given segment—a birth. As disclosed in European Patent Application No. 02077727.2 filed 8 Jul. 2002 (Attorney Docket No. PHNL020598), a start phase may be dropped for very short tracks. In such cases, the decoder uses a random start phase when synthesizing the starting segments of short tracks.

In any case, after a birth, the track is represented in subsequent segments by frequency differences and amplitude differences (continuations) until the segment in which the track ends (death). In practical implementations of prior art encoders, for long or short tracks, phase information is not encoded for continuations at all and phase information is regenerated using continuous phase reconstruction. This is done because transmission of phase information significantly increases the bit rate.

According to the present invention, in order limit divergence between the phase (φₖ) measured by the sinusoidal analyzer 130, when analyzing a signal, and the continuous phase (\tilde{φ}ₖ) generated by both the encoder synthesizer 131 and the corresponding decoder synthesizer 32 when synthesizing the signal, for every n^{th} frame in a track, the sinusoidal analyzer 130 generates a phase update. In the preferred embodiment, n is 4. (If a track is shorter than n frames, no phase update is applied and only the first phase may be transmitted.) Thus, in the synthesizers 131, 32, the phase can only diverge within these n frames, after which the phase is restored again.

In a first embodiment, during the life of a track, the analyzer 130 periodically quantizes the measured phase (φₖ) and includes this value in the sinusoidal code (CS) transmitted to the decoder. Typically, the phase can be accurately and uniformly quantized using 5 bits. It is acknowledged that the phase update requires additional information to be transmitted to the decoder. For a typical set of test signals (audio and speech), the bit rate with phase update for n=4 will increase, depending on the excerpt, by 1-3 kbit/s for a 24 kbit/s sinusoidal coder.

It will be seen that there are several ways to transmit the phase update to the decoder. In the first embodiment, the measured phase is quantized in the same manner as is used to determine the phase of the first sinusoid in a track. For the sinusoid where the phase update occurs, i.e. every n frames, this quantized phase (φₖ) is transmitted.

A second method to transmit the phase update to the encoder is to quantize phase differences for each update point. Thus, the difference between the measured phase and the continuous phase, denoted by Δₖ, is computed by:
Δₖ=mod_{2π}(φₖ−\tilde{φ}ₖ) Equation 2
where \tilde{φ} is defined by Equation 1, k is the frame number in the track and φₖ represents the quantized phase. For example, the difference Δₖ is calculated when k-1 is a multiple of n. For n=4, this means that a phase update happens for frame 1, 5, 9, etc. where phase difference Δₖ is transmitted to the decoder.

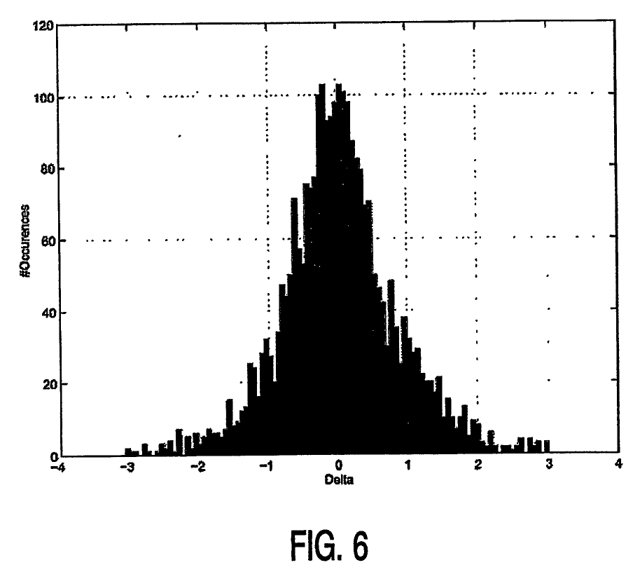

In FIG. 6, the distribution of Δ of the second embodiment for a German male speaker is shown. Due to the peaked distribution around a small range of Δ values, a non-uniform quantization (entropy coding) can be applied such that less than 5 bits per update can be used to provide the same accuracy as the first embodiment. Furthermore, quantization methods similar to those used in Adaptive Differential Pulse Code Modulation (PCM) can be used. In ADPCM, instead of coding an absolute measurement at each sample point, it codes the difference between samples and can dynamically switch the coding scale to compensate for variations in amplitude and frequency. Thus, in the present case, adaptive predictors (based on phase continuation) can be used to vary the phase or phase difference quantization scale. Also, the update rate of the phase, indicated by n, can also be made frequency dependent. For high frequencies, a higher phase updated (smaller n) can be used than for the lower frequencies (higher n).

In any case, the signal x3 remaining after sinusoidal analysis including taking into account phase updates is assumed to mainly comprise noise and the noise analyzer 14 of the preferred embodiment produces a noise code CN representative of this noise, as described in, for example, PCT patent application WO 01/89086-A1 (Attorney Ref: PHNL000287). Again, it will be seen that the use of such an analyzer is not essential to the implementation of the present invention, but is nonetheless complementary to such use.

Finally, in a multiplexer 15, an audio stream AS is constituted which includes the codes CT, CS and CN. The audio stream AS is furnished to e.g. a data bus, an antenna system, a storage medium etc.

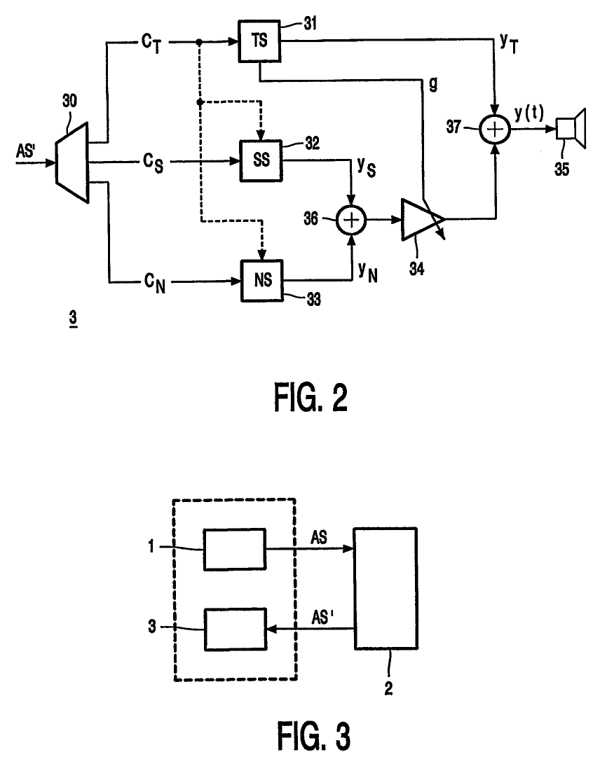

FIG. 2 shows an audio player 3 according to the invention. An audio stream AS′, e.g. generated by an encoder according to FIG. 1, is obtained from the data bus, antenna system, storage medium etc. The audio stream AS is de-multiplexed in a de-multiplexer 30 to obtain the codes CT, CS and CN. These codes are furnished to a transient synthesizer 31, a sinusoidal synthesizer 32 and a noise synthesizer 33 respectively. From the transient code CT, the transient signal components are calculated in the transient synthesizer 31. In case the transient code indicates a shape function, the shape is calculated based on the received parameters. Further, the shape content is calculated based on the frequencies and amplitudes of the sinusoidal components. If the transient code CT indicates a step, then no transient is calculated. The total transient signal yT is a sum of all transients.

The sinusoidal code CS is used to generate signal yS, described as a sum of sinusoids on a given segment. In prior art decoders, in order to decode the frequencies, the continuous phase of a sinusoid in a sinusoidal track is calculated from only the phase of the originating sinusoid and the frequencies of the intermediate sinusoids.

In the decoder of the preferred embodiment, either the transmitted quantized phase φₖ is used to compute the phase difference Δₖ or the phase difference Δₖ is derived directly from the bitstream.

The synthesizers 131, 32 of the preferred embodiments also take into account the possibility of “phase jumps”. A phase jump occurs if the difference between two consecutive phases within a track is large. This can lead to artefacts such as a click. Therefore, in the preferred embodiment, the synthesizers 131, 32 spread the difference between the measured and the continuous phase over the n frames and so, in this case, only a small phase correction per sinusoid is made, such that large phase jumps are avoided.

Thus, the Δₖ is then spread over the current frame and the n−1 preceding frames. This can for example be done in a linear fashion:

$${Δ}_{k}^{′} = \frac{{Δ}_{K}}{n} \qquad Equation 3$$

where K−n<k≦K, where K is the number of the frame in the track where the phase update happens. Other methods are also possible. For example:

$${Δ}_{k}^{′} = \frac{( K - k + n ) \cdot {Δ}_{K}}{( n + 1 ) \cdot n / 2} \qquad Equation 4$$

where K−n<k≦K. In this case, more phase correction is applied to sinusoids closer to the phase update point.

Thus, when synthesizing the sinusoidal components of a signal according to the preferred embodiments of the invention, the continuous phase is calculated by taking into account the interpolated phase differences Δ′ from either Equation 4 or 5 that are needed to update the phase:

$${\tilde{ϕ}}_{k} = {\tilde{ϕ}}_{k - 1} + \frac{L}{2} ( {f}_{k} + {f}_{k - 1} ) + {Δ}_{k}^{′} \qquad Equation 5$$

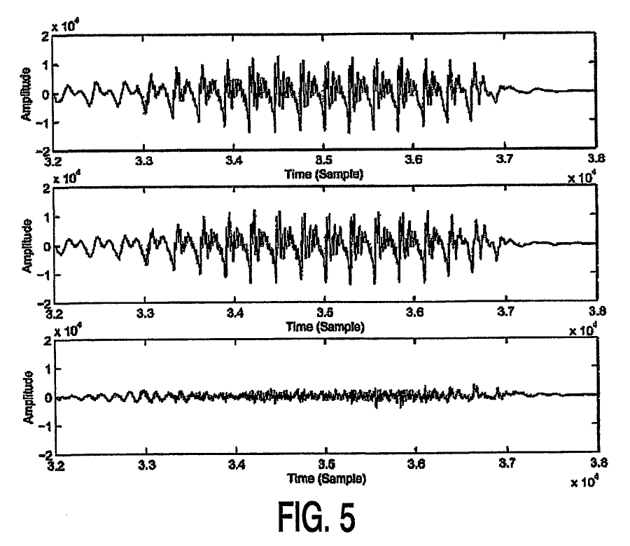

By updating the phase on a regular basis and interpolating the phase difference over the sinusoids in the track, the match between the original signal and the sinusoidal signal with phase update (here n=4) is improved. This is shown in FIG. 5 where it can be seen that the error signal (bottom trace) between the original signal (top trace) and the sinusoidal signal (middle trace) is much reduced compared to FIG. 4.

At the same time, as the sinusoidal components of the signal are being synthesized, the noise code CN is fed to a noise synthesizer NS 33, which is mainly a filter, having a frequency response approximating the spectrum of the noise. The NS 33 generates reconstructed noise yN by filtering a white noise signal with the noise code CN.

The total signal y(t) comprises the sum of the transient signal yT and the product of any amplitude decompression (g) and the sum of the sinusoidal signal yS and the noise signal yN. The audio player comprises two adders 36 and 37 to sum respective signals. The total signal is furnished to an output unit 35, which is e.g. a speaker.

In the preferred embodiments above, the phase update is described as applying to the n frames received prior to the update. It will be seen, however, that the invention is equally applicable to including the phase update information at the beginning of the n frames to which the update applies. In this manner, the phase can be determined with an equation similar to Equation 5 as the information for the frame is received.

Further variations are also possible including, for example, transmitting an indicator as to whether absolute phase values or phase differences are to be transmitted as phase update information. In a similar fashion the use of adaptive updating (varying n) could be signaled in the bitstream. Also, it may be desirable to indicate in the bitstream that for certain frequency ranges, no phase update information will be supplied, as it may be found that using phase update information only benefits sound quality for particular frequency ranges.

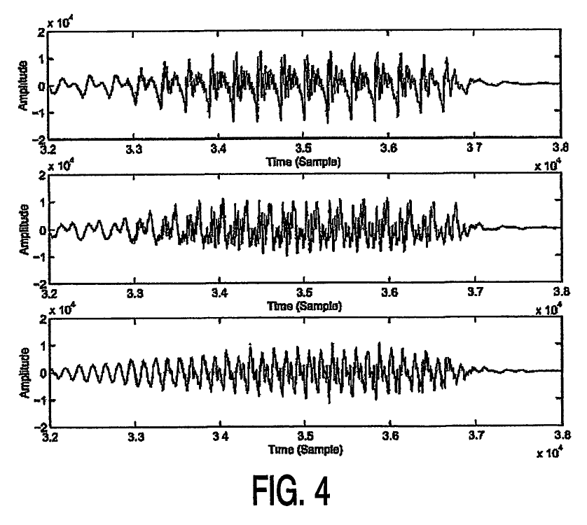

FIG. 3 shows an audio system according to the invention comprising an audio coder 1 as shown in FIG. 1 and an audio player 3 as shown in FIG. 2. Such a system offers playing and recording features. The audio stream AS is furnished from the audio coder to the audio player over a communication channel 2, which may be a wireless connection, a data 20 bus or a storage medium. In case the communication channel 2 is a storage medium, the storage medium may be fixed in the system or may also be a removable disc, memory stick etc. The communication channel 2 may be part of the audio system, but will however often be outside the audio system.

The present invention can be used in any sinusoidal audio coder, where continuous phases are used. As such, the invention is applicable anywhere such coders are employed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding an audio signal, the method comprising the steps of:
providing a respective set of sampled signal values for each of a plurality of sequential segments;
analyzing the sampled signal values to generate one or more sinusoidal components for each of the plurality of sequential segments;
generating sinusoidal codes comprising tracks of linked sinusoidal components;
determining phase update information indicative of the phase value of selected sinusoidal components in a track; and
generating an encoded audio stream including said sinusoidal codes and said phase update information.

2. A method according to claim 1 wherein said phase update information comprises the phase value of selected sinusoidal components.

3. A method according to claim 1 wherein said phase update information comprises a difference between the phase value of selected sinusoidal components and a continuous phase value for said selected sinusoidal components extrapolated from previous phase information through the linked sinusoidal components of a track.

4. A method according to claim 1 in which said phase update information is provided for every nth segment in a track.

5. A method according to claim 4 wherein n=4.

6. A method according to claim 4 wherein n varies according to the frequency of said linked sinusoidal components.

7. A method according to claim 1 wherein said phase update information is quantized according to one of a uniform or a non-uniform scale

8. A method according to claim 1 in which each track comprises a frequency, amplitude and phase for a sinusoidal component in a starting segment of a track and a frequency and amplitude difference for each sinusoidal component in a subsequent continuation segment of said track.

9. A method according to claim 1 further comprising:
synthesizing said sinusoidal components using said sinusoidal codes and said phase update information;
subtracting said synthesized signal values from said sampled signal values to provide a set of values representing a remainder component of said audio signal;
modeling the remainder component of the audio signal by determining parameters, approximating the remainder component; and
including said parameters in said audio stream.

10. A method according to claim 1 wherein said sampled signal values represent an audio signal from which transient components have been removed.

11. Method of decoding an audio stream, the method comprising the steps of:
reading an encoded audio stream including sinusoidal codes comprising tracks of linked sinusoidal components and phase update information indicative of the phase value of selected sinusoidal components in a track; and
employing said sinusoidal codes to synthesize said audio signal including re-constructing sinusoidal components across a plurality of sequential segments as a function of continuous phase information extrapolated from previous phase information through the linked sinusoidal components of a track and said phase update information.

12. A method according to claim 11 in which the phase of said sinusoidal components in a segment k is re-constructed according to the equation:
$${\tilde{ϕ}}_{k} = {\tilde{ϕ}}_{k - 1} + \frac{L}{2} ( {f}_{k} + {f}_{k - 1} ) + {Δ}_{k}^{′}$$
where L is the update interval of the frequencies and where Δ′ₖ is interpolated from said phase update information between selected sinusoidal components.

13. A method according to claim 12 where
$${Δ}_{k}^{′} = \frac{{Δ}_{K}}{n}$$
or
$${Δ}_{k}^{′} = \frac{( K - k + n ) \cdot {Δ}_{K}}{( n + 1 ) \cdot n / 2} ,$$
where n is the number of segments between selected segments, where K−n<k≦K, where K is the number of the selected segment in a track for which phase update information is provided, and where Δₖ comprises a difference between the measured phase value of the selected sinusoidal component and a continuous phase value for the selected sinusoidal component extrapolated from previous phase information through the linked sinusoidal components of a track.

14. Audio coder arranged to process a respective set of sampled signal values for each of a plurality of sequential segments of an audio signal (x), said coder comprising: an analyzer for analyzing the sampled signal values to generate one or more sinusoidal components for each of the plurality of sequential segments;
a component for generating sinusoidal codes comprising tracks of linked sinusoidal components;
means for determining phase update information indicative of the phase value of selected sinusoidal components in a track; and
a bitstream generator for generating an encoded audio stream including said sinusoidal codes and said phase update information.

15. Audio player comprising:
means for reading an encoded audio stream including sinusoidal codes comprising tracks of linked sinusoidal components and phase update information indicative of the phase value of selected sinusoidal components in a track; and
a synthesizer arranged to employ said sinusoidal codes to synthesize said audio signal including re-constructing sinusoidal components across a plurality of sequential segments as a function of continuous phase information extrapolated from previous phase information through the linked sinusoidal components of a track and said phase update information.

16. Audio system comprising an audio coder as claimed in claim 14 and an audio player as claimed in claim 15.

17. Audio stream comprising sinusoidal codes representative of at least a component of an audio signal, said codes comprising tracks of linked sinusoidal components and phase update information indicative of the phase value of selected sinusoidal components in a track.

18. Storage medium on which an audio stream as claimed in claim 17 has been stored.
